(19) United States
(12) Patent Application Publication
(10) Pub. No.: US 2007/0252429 A1
(43) Pub. Date: Nov. 1, 2007

(54) Motorcycle Brake System

(76) Inventors: Jens Lerchenberger, Vienenburg (DE); Andreas Neu, Kuhardt (DE); Reinhold Kascha, Altenstadt (DE)

Correspondence Address: RATNERPRESTIA, P O BOX 980, VALLEY FORGE, PA, 19482-0980, US

(21) Appl. No.: 11/664,489

(22) PCT Filed: Sep. 28, 2005
(86) PCT No.: PCT/EP05/54881

§ 371 Date: Apr. 2, 2007

(30) Foreign Application Priority Data
Oct. 7, 2004 (DE) 102004048823.1
Jan. 27, 2005 (DE) 102005003774.7

(51) Int. Cl. B60T 8/34; B60T 13/10

(52) U.S. Cl. 303/113.2; 303/20

(57) ABSTRACT

A hydraulic motorcycle brake system includes means for the redundant measurement of the master brake cylinder pressure introduced into the front-wheel brake circuit.

### RELATED APPLICATIONS

This application is the U.S. national phase application of PCT International No. PCTEP2005/054881, filed Sep. 28, 2005, which claims priority to German Patent Application No. DE102004048823.1, filed Oct. 7, 2004 and German Patent Application No. DE102005003774.7, filed Jan. 27, 2005, the contents of such patents being incorporated by reference herein.

### BACKGROUND OF THE INVENTION

The present invention relates to a motorcycle brake system.

### DESCRIPTION OF THE RELATED ART

EP 1 277 635 A2 discloses a motorcycle brake system. The brake system includes a hydraulically operable front-wheel and rear-wheel brake circuit comprising a pair of foot-operated or manually operated master brake cylinders. For brake slip control, electromagnetically activatable inlet and outlet valves are mounted in the front-wheel and rear-wheel brake circuits, as well as a pump for pressure buildup in the two brake circuits irrespective of the actuation of the two master brake cylinders.

A first pressure sensor is arranged between the inlet valve and the master brake cylinder at the front-wheel brake circuit to sense the master brake cylinder pressure delivered to the front-wheel brake circuit. A second pressure sensor senses the wheel brake pressure in a rear-wheel brake connected to the rear-wheel brake circuit. In addition, a pressure sensor sensing the master brake cylinder pressure in the rear-wheel brake circuit can be provided close to the master brake cylinder operating the rear-wheel brake.

To allow detection of the actuation of the master brake cylinder connected to the front-wheel brake circuit in the prior art motorcycle, proper functioning of the first pressure sensor is particularly significant, for what reason any possible error of the first pressure sensor must be reliably identified. Depending on the reliable detection of the master brake cylinder pressure in the front-wheel brake circuit, a hydraulic pressure in the rear-wheel brake can then be built up according to a brake force distribution characteristic curve.

### SUMMARY OF THE INVENTION

The invention relates to a motorcycle brake system designed in such a fashion that safe detection of the master brake cylinder pressure introduced into the front-wheel brake is safeguarded.

### BRIEF DESCRIPTION OF THE DRAWINGS

Further features and advantages of the invention can be taken from the subsequent description of an embodiment for a motorcycle brake system.

FIG. 1 shows a schematic view of the motorcycle brake system according to the invention.

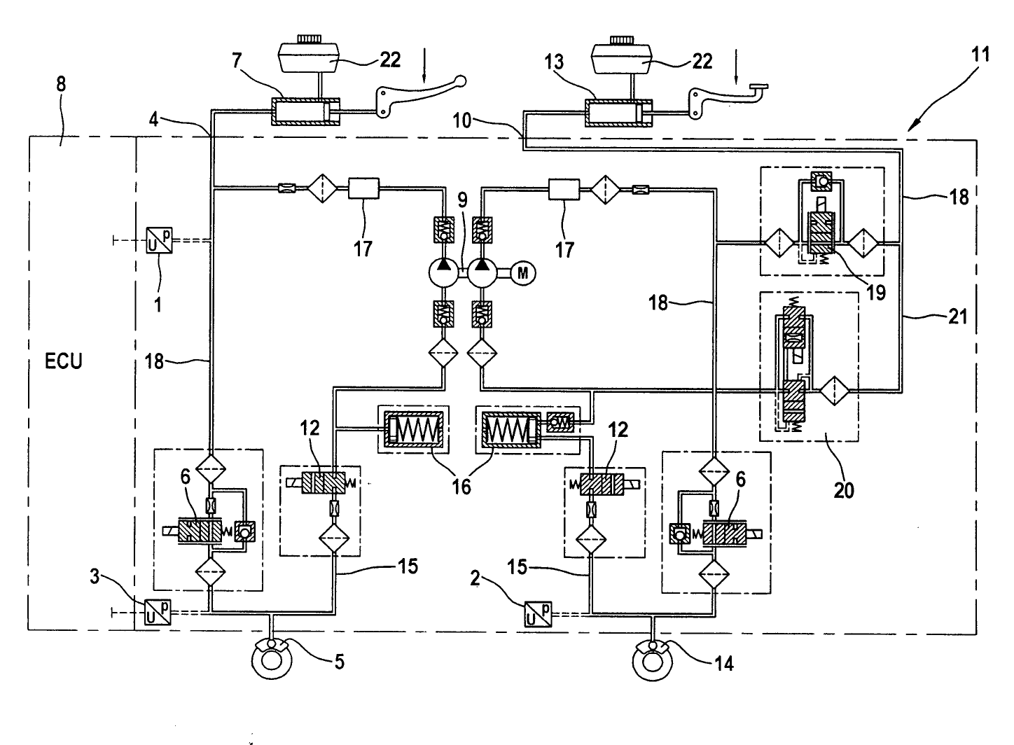

### DETAILED DESCRIPTION OF THE PREFERRED EMBODIMENTS

The brake system comprises a hydraulically operable front-wheel and rear-wheel brake circuit 4, 10, with each one master brake cylinder 7 connected to the front-wheel brake circuit 4 and operable proportionally by manual force and a master brake cylinder 13 at the rear-wheel brake 14 that is operable proportionally to leg force.

For brake slip control, electromagnetically operable inlet and outlet valves 6, 12 are fitted in the front-wheel and rear-wheel brake circuits 4, 10, and the inlet valve 6 that is open in its basic position is inserted into the brake line of the front-wheel or rear-wheel brake circuit 4, 10, which connects the associated master brake cylinder 7, 13 to the front-wheel or rear-wheel brake 5, 14, respectively. The outlet valve 12 that is closed in its basic position is respectively inserted into a return line 15 of each brake circuit, which connects the front-wheel or rear-wheel brakes 5, 14 to respectively one low-pressure accumulator 16 and the suction side of a dual-circuit pump 9, which operates according to the return principle. The pump 9 is in connection with the brake lines 18 by way of noise-damping chambers 17 inserted into the two brake circuits so that a return delivery of the brake fluid volume discharged in each case from the front-wheel or rear-wheel brake 5, 14 is safeguarded in conformity with requirements.

In addition to the features of the front-wheel brake circuit 4 described hereinabove, the rear-wheel brake circuit 10 includes an electromagnetically operable separating valve 19, which is open in its basic position and is inserted into the brake line 18 between the master brake cylinder 13 and the inlet valve 6. Further, a suction conduit 21 that leads to the pump 9 by way of an electric change-over valve 20 is connected between the separating valve 19 and the master brake cylinder 13 to the brake line 18 of the rear-wheel brake circuit 10, with the result that the pump component acting in the rear-wheel brake circuit 10 is able to take pressure fluid for pressure build up in the rear-wheel brake 14 from the master brake cylinder 13 and the supply tank 22 connected to the master brake cylinder 13, with the change-over valve 20 being electrically energized, and to deliver it to the rear-wheel brake 14, while the separating valve 19 stays in its electrically energized closed position.

A first pressure sensor 1 is arranged at the brake line 18 of the front-wheel brake circuit 4 upstream of the inlet valve 6 in order to sense the master brake cylinder pressure supplied to the front-wheel brake circuit 4. A second sensor 2 is connected to the rear-wheel brake circuit downstream of the inlet valve 6 in order to sense the wheel brake pressure in the rear-wheel brake circuit 10.

The inlet valves 6 allow limiting the brake pressure generated in the brake lines 18 in the dual-circuit brake system at any time. Brake pressure reduction in the wheel brakes is performed using the outlet valves 12, which can be opened electromagnetically in the direction of the two low-pressure accumulators 16.

To precisely sense the pressure introduced by the master brake cylinder 7 into the front-wheel brake circuit 4, the invention provides an appropriate means for the redundant measurement of the hydraulic pressure that prevails in the front-wheel brake circuit, to what end a third pressure sensor is arranged in the motorcycle brake system, which senses the hydraulic pressure in the front-wheel brake circuit 4 in addition to the first pressure sensor 1.

Expediently, the pressure sensor is used as the third pressure sensor 3 which is known from the cited prior art and previously sensed the master brake cylinder pressure at the rear-wheel brake circuit so that the total number of pressure sensors used for the motorcycle brake system favorably remains the same.

Advantageously, the third pressure sensor 3 is connected in series to the first pressure sensor 1 at the front-wheel brake circuit 4. The advantage involved is that both the master brake cylinder pressure and the front-wheel brake pressure can be sensed in conformity with requirements due to a correspondingly suitable positioning of the first and third pressure sensors 1, 3. Therefore, the third pressure sensor 3 is connected to the front-wheel brake circuit 4 between the front-wheel brake 5 and the inlet valve 6, while the first pressure sensor 1 is connected to the front-wheel brake circuit 4 between the inlet valve 6 and the master brake cylinder 7 connected to the front-wheel brake circuit 4.

The master brake cylinder pressure, which is sensed redundantly in the front-wheel brake circuit 4 by means of the two pressure sensors 1, 3, represents the command variable for the electric activation of the pump 9 that is mounted in the rear-wheel brake circuit 10 and, in cooperation with the inlet and outlet valves 6, 12, the separating and change-over valves 19, 20, brings about an automatic brake pressure build-up in the rear-wheel brake circuit 10 according to an electronic brake-force distribution characteristic curve that is stored in the control unit 8, when exclusively the master brake cylinder 8 connected to the front-wheel brake circuit 4 is actuated.

To evaluate signals of the first, second, and third pressure sensor 1, 2, 3, a logic circuit is provided in the electronic control unit 8, in which a hydraulic pressure in the rear-wheel brake circuit 10 is produced by means of the electrically actuatable pump 9 depending on the result of evaluation of the pressure sensor signals.

Further, the electronic control unit 8 comprises a plausibility circuit in which the signals of the first pressure sensor 1, which generates nominal values, are compared with the signals of the third pressure sensor 3 before the pump 9 is activated for pressure build-up in the rear-wheel brake circuit 10.

The control unit 8 forms an integral component of a brake unit 11 and is favorably plugged onto the three pressure sensors 1, 2, 3 integrated in the brake unit 11 and the inlet and outlet valves 6, 12 integrated in the sensors for electrical contacting purposes. Thus, the brake unit 11 allows being fastened to a motorcycle frame close to a battery due to the especially compact construction.

The arrangement of the third pressure sensor 3, as chosen, permits improving the brake pressure control comfort during a brake slip control operation due to the information about the pressure in the front-wheel brake 5, and minimizing the hydraulic reaction of the pressure control pulses provoked by the inlet and outlet valves 6, 12 to the (manually) operated master brake cylinder.

Principally, the following applies:
1. A tendency to lock of the front wheel or rear wheel is reliably detected by means of wheel rotational speed sensors (not shown) and their signal evaluation in the control unit 8. The inlet valve 6 arranged in the front-wheel or the rear-wheel brake circuit 4, 10 is closed electromagnetically by way of the control unit 8 in order to discontinue further pressure development in the front-wheel or rear-wheel brake circuit 4, 10.
2. Should further pressure decrease be required in addition in the front-wheel or rear-wheel brake circuit 4, 10 in order to reduce the tendency to lock, this is achieved by opening the normally closed outlet valve 12 that is connectible to the low-pressure accumulator 16. The outlet valve 12 is closed as soon as the wheel acceleration re-increases beyond a defined extent. In the pressure decrease phase the corresponding inlet valve 6 remains closed so that the master brake cylinder pressure generated in the front-wheel or rear-wheel brake circuit 4, 10 cannot propagate to the front-wheel or rear-wheel brake circuit 4, 10.
3. When the slip values found permit pressure build-up in the front-wheel or rear-wheel brake circuit 4, 10 again, the inlet valve 6 is opened in a temporally limited manner to comply with the demand of the slip controller integrated in the control unit 8. Pump 9 supplies the hydraulic volume required for pressure build-up.

Outside brake slip control, exclusively a force-proportional pressurization of the rear-wheel brake 14 occurs due to the hydraulic circuit concept when the master brake cylinder 13 connected to the rear-wheel brake circuit 10 is actuated (proportionally to leg force), i.e. the front-wheel brake circuit 4 stays unpressurized until the master brake cylinder 7 connected to the front-wheel brake circuit 4 is actuated (proportionally to manual force).

It is considered another special feature of the motorcycle brake system presented that the rear-wheel brake is also braked by an appropriate pump actuation when the front-wheel brake circuit is actuated proportionally to force. To this end, the pump 9 removes pressure fluid from the master brake cylinder 13 through the electrically opened change-over valve 20 and delivers it to the rear-wheel brake 14. As this occurs, the separating valve 19 remains in the closed position in an electrically operated manner, whereby it is safeguarded that the pump pressure does not escape into the master brake cylinder 13.

The selected design of the disclosed motorcycle brake system offers a particularly safe and comfortable actuation and simultaneously enhances the pressure control characteristics in the locking pressure control case.

1-10. (canceled)

11. A motorcycle brake system with a hydraulically operable front-wheel and rear-wheel brake circuit, comprising two master brake cylinders for the independent actuation of both brake circuits, an inlet and an outlet valve provided in each brake circuit for brake slip control, a first pressure sensor to sense the master cylinder pressure that can be supplied to the front-wheel brake circuit, and a second pressure sensor to sense the wheel brake pressure in a rear-wheel brake connected to the rear-wheel brake circuit, the pressure supply of the front-wheel and rear-wheel brake circuits each having a pump, the supply pressure of the pump that is active in the rear-wheel brake circuit being applicable to the rear-wheel brake depending on a force-proportional actuation of the master brake cylinder connected to the front-wheel brake circuit, and;
for the force-proportional braking operation in the front-wheel brake circuit, a means is provided for the redundant measurement of the hydraulic pressure that can be introduced from the master brake cylinder.

12. The motorcycle brake system as claimed in claim 11,
wherein the means for redundant measurement is a third pressure sensor arranged in the front-wheel brake circuit.

13. The motorcycle brake system as claimed in claim 12,
wherein the third pressure sensor is connected to the front-wheel brake circuit in series to the first pressure sensor, with the third pressure sensor being connected to the front-wheel brake circuit between the front-wheel brake and the inlet valve, and in that the first pressure sensor is connected to the front-wheel brake circuit between the inlet valve and the master brake cylinder connected to the front-wheel brake circuit.

14. The motorcycle brake system as claimed in claim 12,
wherein the front-wheel brake pressure can be sensed for the purpose of improving the brake pressure control quality by means of the third pressure sensor in a brake slip control phase, in which the pressure in the front-wheel brake shall be maintained or reduced.

15. The motorcycle brake system as claimed in claim 11,
wherein the third pressure sensor is shifted in position from the master brake cylinder connection at the rear-wheel brake circuit to the wheel brake connection at the front-wheel brake circuit.

16. The motorcycle brake system as claimed in claim 12,
wherein the signals of the first and third pressure sensors are used to redundantly sense the hydraulic pressure in the front-wheel brake circuit as a command variable for the additional pump-aided pressure build-up in the rear-wheel brake circuit.

17. The motorcycle brake system as claimed in claim 12,
wherein for the evaluation of signals of the first, second and third pressure sensor, a logic circuit is provided in an electronic control unit, in which a hydraulic pressure in the rear-wheel brake circuit can be produced by means of the electrically actuatable pump depending on the result of evaluation of the pressure sensor signals.

18. The motorcycle brake system as claimed in claim 17,
wherein the electronic control unit comprises a plausibility circuit in which the signals of the first pressure sensor can be compared with the signals of the additional pressure sensor.

19. The motorcycle brake system as claimed in claim 17,
wherein the control unit forms an integral component of a brake unit, said control unit plugged onto the three pressure sensors integrated in the brake unit and the inlet and outlet valves integrated in the sensors for electrical contacting purposes.

20. The motorcycle brake system as claimed in claim 19,
wherein the brake unit is fastened to a motorcycle frame close to a battery.
